(19) United States
(12) Patent Application Publication
(10) Pub. No.: US 2010/0169107 A1
(43) Pub. Date: Jul. 1, 2010

(54) METHOD AND APPARATUS FOR INTEGRATED PERSONAL GENOME MANAGEMENT

(75) Inventors: Tae-jin Ahn, Seoul (KR); Kyu-sang Lee, Suwon-si (KR); Dae-soon Son, Seoul (KR); Kyung-hee Park, Seoul (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/623,893

(22) Filed: Nov. 23, 2009

(30) Foreign Application Priority Data
Dec. 30, 2008 (KR) 10-2008-0137164

(51) Int. Cl. G06F 17/30; G06Q 99/00; G06F 21/00

(52) U.S. Cl. 705/1.1; 707/609; 707/758; 726/4; 707/E17.005; 707/E17.014

(57) ABSTRACT

Provided are a method and an apparatus for managing data indicating personal genome data. The method includes obtaining property information of a first personal genome data, which indicates genome information of an individual, by analyzing a first personal genome data, and generating integrated data by integrating the first personal genome data and a second personal genome data indicating genome data of the individual based on the obtained property information.

### CROSS-REFERENCE TO RELATED APPLICATIONS

This application claims priority to Korean Patent Application No. 10-2008-0137164, filed on Dec. 30, 2008, and all the benefits accruing therefrom under 35 U.S.C. §119, the contents of which in its entirety herein incorporated by reference.

### BACKGROUND

1. Field

One or more embodiments relate to a method and an apparatus for managing data indicating personal genome data.

2. Description of the Related Art

Genome means all genetic information of a living organism. More precisely, genome of an organism is a complete genetic sequence, including both the genes and the non-coding sequences present in the genetic information of a living organism. Presently, there are various techniques and apparatus for analyzing genome of an individual. For example, many genome detecting devices, such as a DNA chip for detecting single nucleotide polymorphism (SPN), copy number variation (CNV), etc., have been have been developed and commercialized. Techniques for sequencing the genome of an individual are still being developed. Although there are various techniques for analyzing the genome of an individual in development, i.e., next generation sequencing techniques, and following generation sequencing techniques, have yet reached the commercialization stage. The next generation techniques for analyzing the genome of an individual in development may include personal genome information prepared using a different format or prepared by a currently unknown or non-commercialized techniques and apparatus for analyzing genome of an individual. Therefore, the content of data indicating personal genome information may be altered according to technical developments in techniques and apparatus for sequencing genome and devices for detecting and analyzing the genome. For this reason, there is a need for methods and for an apparatus for managing personal genome data according to variations and developments in genome sequencing techniques and genome detecting devices.

### SUMMARY

One or more embodiments include a method for consistent management of personal genome data without being restricted by various structures of personal genome data due to developments in techniques of sequencing genome and devices for detecting or differences in genome detecting devices.

One or more embodiments include an apparatus for consistent management of personal genome data without being restricted by various structures of personal genome data due to developments in techniques of sequencing genome and devices for detecting genome or differences in genome detecting devices.

One or more embodiments include a computer readable recording medium having recorded thereon a computer program for executing the method for consistent management of personal genome data without being restricted by various structures of personal genome data due to developments in techniques of sequencing genome and devices for detecting or differences in genome detecting devices.

Additional embodiments will be set forth in part in the description which follows and, in part, will be apparent from the description, or may be learned by practice of the invention.

Another embodiment includes a method of performing integrated personal genome management, the method including obtaining property information of first data, which indicates genome information of an individual, by analyzing the first data, and generating integrated data by integrating the first data and second data indicating genome data of the individual based on the obtained property information.

A further embodiment includes a computer readable recording medium having recorded thereon a computer program for executing the method of performing integrated personal genome management.

A further embodiment includes an apparatus for integrated personal genome management, the apparatus including an analyzing unit which obtains property information of first data, which indicates genome information of an individual, by analyzing the first data, and a generating unit which generates integrated data by integrating the first data and second data indicating genome data of the individual based on the obtained property information.

A further embodiment includes a method of comparing personal genomes, the method including obtaining property information of first data, which indicates genome information of an individual, by analyzing the first data, generating integrated data by integrating the first data and second data indicating genome data of the individual based on the obtained property information, and comparing the integrated data and other data that has a structure the same as that of the integrated data.

Another embodiment includes a computer readable recording medium having recorded thereon a computer program for executing the method of comparing personal genomes.

A further embodiment includes an apparatus for comparing personal genomes, the apparatus including an analyzing unit which obtains property information of first data, which indicates genome information of an individual, by analyzing the first data, a generating unit which generates integrated data by integrating the first data and second data indicating genome data of the individual based on the obtained property information, and a comparing unit which compares the integrated data and other data that has a structure the same as that of the integrated data.

A further embodiment includes a method of providing personal genome services, the method including transmitting contents respectively indicating services of providing medical analysis with respect to an individual by using genome information of the individual, to a user terminal, receiving selection information with respect to at least one of the contents of the services, from the user terminal, executing the service indicated by the received selection information by using integrated data in which first data, which indicates genome information of the individual, and second data, which indicates genome information of the individual, are integrated, and transmitting a result of the service execution to the user terminal.

Furthermore, is an embodiment for a computer readable recording medium having recorded thereon a computer program for executing the method of providing personal genome services.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is a block diagram of an exemplary embodiment of an apparatus for integrated personal genome management;

FIG. 2 is a flowchart of an exemplary embodiment of a method of integrated personal genome management;

FIG. 3 is a detailed flowchart of an exemplary embodiment of operation 21 shown in FIG. 2;

FIG. 4 is a diagram showing of an exemplary embodiment of personal genome data input to a data analyzing unit shown in FIG. 1;

FIG. 5 is a diagram showing an exemplary embodiment of the structure of a PGF generated by an integrated data generating unit shown in FIG. 1;

FIG. 6 is a diagram showing an exemplary embodiment of encoding genotype information shown in FIG. 5;

FIG. 7 is a detailed flowchart of an exemplary embodiment of operation 22 shown in FIG. 2;

FIG. 8 is a diagram showing an exemplary embodiment of the assortment of genotype information within the PGF shown in FIG. 5;

FIG. 9 is a detailed flowchart of an exemplary embodiment of operations 24 and 25 shown in FIG. 2;

FIG. 10 is a diagram of an exemplary embodiment of a service history generated in operation 98 of FIG. 9;

FIG. 11 is a diagram showing an exemplary embodiment of selection of indexes by an index selecting unit shown in FIG. 1;

FIG. 12 is a diagram showing an exemplary embodiment of the storage of indexes in a storage unit shown in FIG. 1;

FIG. 13 is a detailed flowchart of an exemplary embodiment of operation 27 shown in FIG. 2;

FIG. 14 is a diagram showing an exemplary embodiment of data comparison performed by a data comparing unit shown in FIG. 1; and

FIG. 15 is a diagram showing an exemplary embodiment of data comparison performed by the data comparing unit shown in FIG. 1.

### DETAILED DESCRIPTION

Reference will now be made in detail to embodiments, examples of which are illustrated in the accompanying drawings, wherein like reference numerals refer to like elements throughout.

Aspects, advantages and features of exemplary embodiments of the invention and methods of accomplishing the same may be understood more readily by reference to the following detailed description of embodiments and the accompanying drawings. The exemplary embodiments of the invention may, however, may be embodied in many different forms, and should not be construed as being limited to the embodiments set forth herein. Rather, these embodiments are provided so that this disclosure will be thorough and complete and will fully convey the concept of the invention to those skilled in the art, and the exemplary embodiments of the invention will only be defined by the appended claims. Like reference numerals refer to like elements throughout the specification.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, the term “and/or” includes any and all combinations of one or more of the associated listed items.

It will be understood that, although the terms first, second, third, etc., can be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the exemplary embodiments of the invention.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

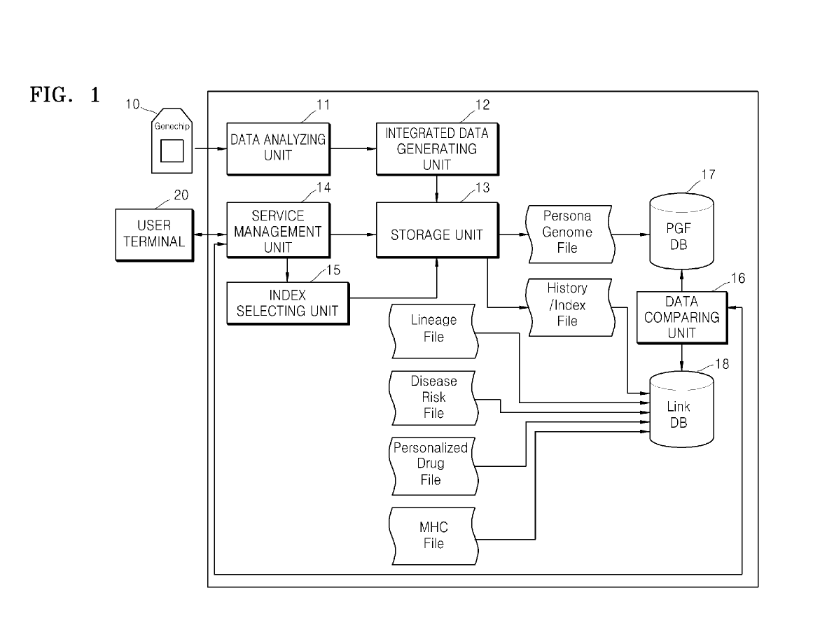

FIG. 1 is a block diagram of an embodiment of an apparatus for integrated personal genome management. Referring to FIG. 1, according to one embodiment, the apparatus for integrated personal genome management includes a data analyzing unit 11, an integrated data generating unit 12, a storage unit 13, a service management unit 14, an index selecting unit 15, a data comparing unit 16, a personal genome file (PGF) database 17, and a link database 18. In one embodiment, the apparatus for integrated personal genome management further comprises a genome detecting device 10 and a user terminal 20. Furthermore, it will be understood by those of ordinary skill in the art that an apparatus for comparing genomes of individuals and other apparatuses can also be easily embodied by selectively combining the components described above.

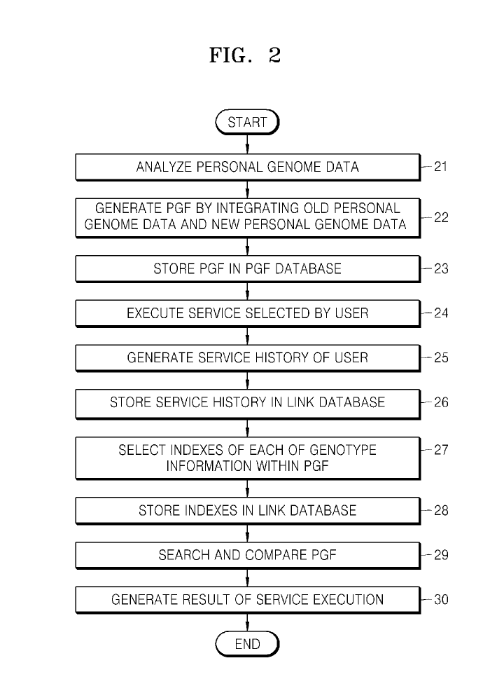

FIG. 2 is a flowchart of an embodiment of a method of integrated personal genome management. Referring to FIG. 2, one embodiment of the method of integrated personal genome management includes operations described below that are carried out sequentially by the apparatus for integrated personal genome management of FIG. 1. Furthermore, it will be understood by those of ordinary skill in the art that a method of comparing genomes of individuals, providing a personal genome service, and other methods can also be easily embodied by selectively combining the operations described below.

In operation 21, the apparatus for integrated personal genome management receives an input of data indicating genome information of an individual (will be hereinafter referred as ‘personal genome data’) from a genome detecting device 10, and obtains property information of the personal genome data and genetic polymorphism information of the individual by analyzing the personal genome data. In operation 22, the apparatus for integrated personal genome management generates integrated data by combining personal genome data already stored in the PGF database 17 and with the personal genome data input to the data analyzing unit 11, according to the property information obtained in operation 21. Said another way, in operation 22, the apparatus for integrated personal genome management integrates the property information of the personal genome data and genetic polymorphism information obtained from the genome detecting device 10 with any personal genome data already stored in the PGF database 17. In operation 23, the apparatus for integrated personal genome management stores the integrated data, generated in operation 22, that is, a binary PGF file, in the PGF database 17.

In operation 24, the apparatus for integrated personal genome management executes at least one service selected by a user from among services that can be provided by the apparatus for integrated personal genome management. In operation 25, the apparatus for integrated personal genome management generates a service history of a user, based on a result of the execution in the operation 24. The service history may be stored in the link database 18. In operation 26, the apparatus for integrated personal genome management stores the generated service history in the link database 18.

Based on the service histories stored in the link database 18, the apparatus for integrated personal genome management selects indexes for integrated data stored in the PGF database 17, that is, indexes for each of genotype information within the PGF file (operation 27). In operation 28, the apparatus for integrated personal genome management maps each of the selected indexes to corresponding genotype information, that is, IDs of single nucleotide polymorphisms (SNPs), and stores them in the link database 18. In operation 29, the apparatus for integrated personal genome management searches for a PGF file containing personal genome data required for the service management unit 14 to execute a service by referring to link data stored in the link database 18 and compares personal genome data within a searched file. In operation 30, the apparatus for integrated personal genome management generates a report of service execution using a result of the comparison in the operation 28 and transmits the report of service execution to a user terminal 20.

In one embodiment, the data analyzing unit 11 receives an input of data indicating genome information of an individual from the genome detecting device 10. The data analyzing unit 11 analyzes the personal genome data of the individual and obtains property information of the personal genome data and genetic polymorphism information of the individual. The property information of the personal genome data includes information regarding a manufacturer of the genome detecting device 10 which generated the personal genome data, a version of the genome detecting device 10, a version of an algorithm the genome detecting device 10 used to generate the personal genome data, etc. Furthermore, the genetic polymorphism information refers to information regarding genetic differences between individuals; e.g. SNP information, etc.

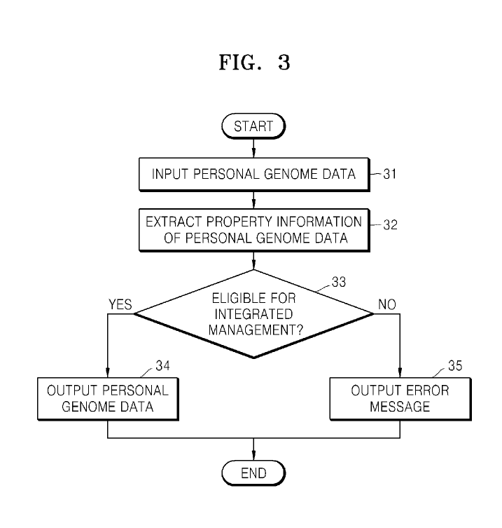

FIG. 3 is a detailed flowchart of an embodiment of the operation 21 shown in FIG. 2. Referring to FIG. 3, the operation 21 shown in FIG. 2 includes operations that will be described below that are executed sequentially by the data analyzing unit 11 of FIG. 1.

Referring to FIG. 3, in operation 31, the data analyzing unit 11 receives personal genome data input from the genome detecting device 10. In operation 32, the data analyzing unit 11 extracts property information of the received personal genome data from a header of the received personal genome data, and extracts genetic polymorphism information of an individual from remaining portions of the received personal genome data excluding the header by parsing the received personal genome data. Generally, each genome detecting devices 10, particularly genome detecting devices manufactured by different provides, defines a unique data structure. In one embodiment, the header includes information regarding a manufacturer of the genome detecting device 10 which generated corresponding genome data, information regarding the version of the genome detecting device 10, and information regarding the version of a corresponding algorithm the genome detecting device 10 used for generating the personal genome data. Thus, the data analyzing unit 11 extracts property information of personal genome data and genetic polymorphism information of an individual by using a method which conforms to a corresponding data structure.

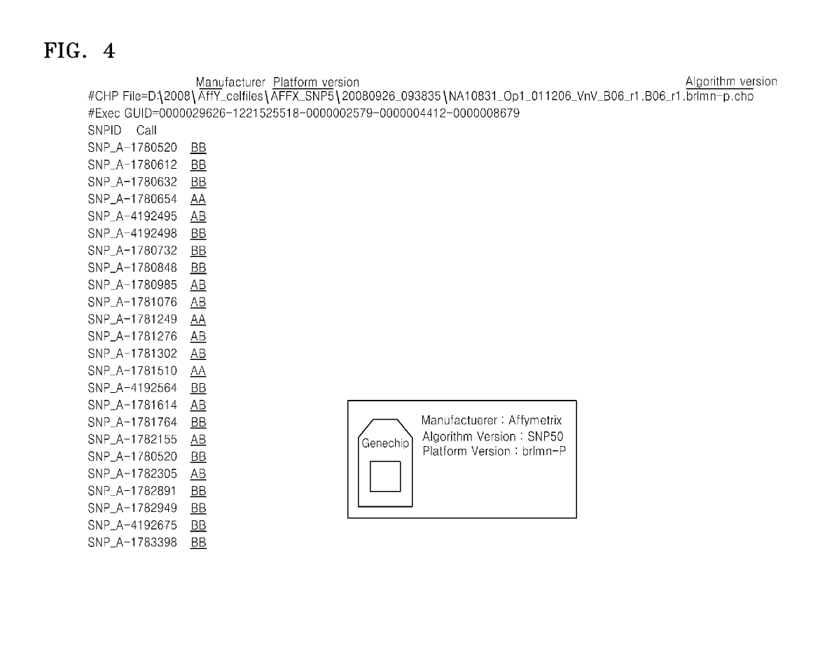

FIG. 4 is a diagram showing an example of personal genome data input to the data analyzing unit 11 shown in FIG. 1. Referring to FIG. 4, the data analyzing unit 11 obtains property information of the personal genome data by parsing the personal genome data provided from the genome detecting device 10. Referring to FIG. 4, the example property information provided in the header indicates the genome detecting device 10 used for generating personal genome data was a DNA chip manufactured by Affymetrix, that the version of the genome detecting device 10 is 5.0, and that the version of an algorithm used for generating the personal genome data is brlmn-p from. The data analyzing unit 11 further obtains genetic polymorphism information of an individual, that is, SNP information, from remaining portions of the personal genome data excluding the header.

Referring again to FIG. 3, in operation 33, the data analyzing unit 11 determines whether the personal genome data input in operation 31 is eligible for integrated management or not, based on the property information extracted in the operation 32. More particularly, the data analyzing unit 11 determines whether the personal genome data is eligible for integrated management or not by confirming whether the property information of the personal genome data input in operation 32 is registered to a list of property information of personal genome data input in operation 31. As a result, if the property information extracted in the operation 32 is registered to the list of property information of the personal genome data, that is, if the personal genome data is eligible for integrated management, the method proceeds to operation 34. If the personal genome data is not eligible for integrated management, the method proceeds to operation 35.

In particular, for efficient registration confirmation, a representative value may be allocated to property information of personal genome data. In this case, a representative value allocated to property information of personal genome data is recorded in a list of property information of personal genome data, instead of recording the property information itself. In operation 33, the data analyzing unit 11 compares a representative value of the property information extracted in operation 32 and representative values of property information in the list of property information of personal genome data to confirm whether the property information extracted in operation 32 is registered to the list of property information of personal genome data or not. In other words, if the representative value of the property information extracted in operation 32 is equal to any one of the representative values of the property information in the list of property information of personal genome data, the data analyzing unit 11 confirms that the property information extracted in the operation 32 is registered to the list of property information of personal genome data. If the representative value of the property information extracted in operation 32 is not equal to any of the representative values of the property information in the list of property information of personal genome data, the data analyzing unit 11 confirms that the property information extracted in operation 32 is not registered to the list of property information of personal genome data.

In operation 34, the data analyzing unit 11 outputs the property information and the genetic polymorphism information that are extracted in operation 32. In operation 35, the data analyzing unit 11 outputs an error message indicating that the personal genome data input by the genome detecting device 10 is not eligible for integrated management. The error message may also include a request to update the list of property information of personal genome data, so that the personal genome data input by the genome detecting device 10 become eligible for integrated management.

Based on property information obtained by the data analyzing unit 11, the integrated data generating unit 12 generates integrated data by integrating personal genome data already stored in the PGF database and personal genome data input via the data analyzing unit 11. While such genome data may have different structures, integrated data according to the current embodiment is embodied as a binary personal genome file (PGF) having a unified data structure. The fact that a plurality of genome data have different data structures indicates that the plurality of genome data differ in terms of at least one of elements constituting property information of each of the genome data, which are, information regarding a manufacturer which manufactured a genome detecting device 10 which generated corresponding genome data, information regarding a version of the genome detecting device 10, and information regarding a version of a corresponding algorithm the genome detecting device 10 used for generating the personal genome data. For example, an individual may have different versions of genome data according to versions of the genome detecting device 10. In this case, the integrated data generating unit 12 generates integrated data by integrating old versions of personal genome data already stored in the PGF database 17 and a new version of personal genome data, based on property information obtained by the data analyzing unit 11.

Accordingly, the current embodiment provides a PGF having a unified data structure, which is not subordinated to a manufacturer of a genome detecting device 10 which generated personal genome data, a version of the genome detecting device 10, and a version of an algorithm used by the genome detecting device 10 to generate the personal genome data. According to the current embodiment, personal genome data, of which content may vary according to developments in genome sequencing techniques and genome detecting devices, can be consistently managed. Furthermore, it is only necessary to store single genome information according to a structure according to the current embodiment rather than storing various genome information which differ in terms of manufacturers of a genome detecting device 10, a version of the genome detecting device 10, and a version of an algorithm, and thus storage space required for storing personal genome data can be reduced.

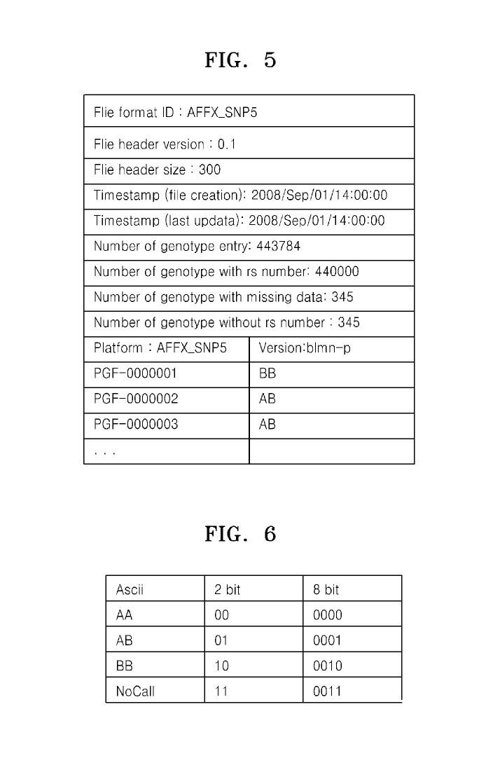

FIG. 5 is a diagram showing an exemplary embodiment of the structure of a PGF generated by the integrated data generating unit 12 shown in FIG. 1. Referring to FIG. 5, a PGF includes a header in which information regarding the PGF is recorded and a portion in which genetic polymorphism information of an individual is recorded. The header includes a field in which an ID indicating the structure of the PGF is recorded, a field in which a version of the PGF header is recorded, a field in which the size of the PGF header is recorded, a field in which a point of time at which the PGF is generated is recorded, a field in which a point of time at which the latest update of the PGF is performed, a field in which a number of genotype entries is recorded, a field in which a number of genotypes having reference snp (rs) numbers is recorded, a field in which a number of genotypes without data is recorded, a field in which a number of genotypes without rs numbers is recorded, a field in which information regarding the genome detecting device 10 is recorded, a field in which a version of an algorithm used for generating genome data is recorded, etc.

Meanwhile, the portion in which genetic polymorphism information of an individual is recorded includes a plurality of fields in which IDs, which respectively indicate a plurality of genotypes constituting the genetic polymorphism information of an individual, are recorded and a plurality of fields in which genotype information respectively corresponding to the IDs are recorded. In particular, to integrate various versions of genome data into a single piece of genome data, the SNP ID (that is, rs number) and the genotype calls, which are genotype information corresponding to the IDs, shown in FIG. 4, are converted into the SNP ID and the genotype calls shown in FIG. 5. For example, the SNP ID “SNP_A-1780520” and the genotype call “BB” are converted into “PGF-0000001” and “BB,” respectively.

FIG. 6 is a diagram showing an example of encoding the genotype information shown in FIG. 5. As shown in FIG. 5, there are three types of genotype information using SNP, that is, genotype calls, which are AA, AB, and BB, and “No Call” indicates that information regarding a genotype is not detected by the genome detecting device 10. If one of two allele inherited from parents is indicated as ‘A,’ the other one is indicated as ‘B.’ In a group, there are three types of people having allele of particular positions, which are AA, AB, and BB. Here, NN (“No Call,” which indicates that the genotype cannot be determined) is added thereto, so that can be classified in four types. Therefore, as shown in FIG. 6, genotype information using SNP can be encoded as 2-bit data. Furthermore, in the case where it is more advantageous to encode genotype information in a unit of 1-byte due to characteristics of a system to which the current embodiment is applied, genotype information using SNP can be encoded as 8-bit data as shown in FIG. 6.

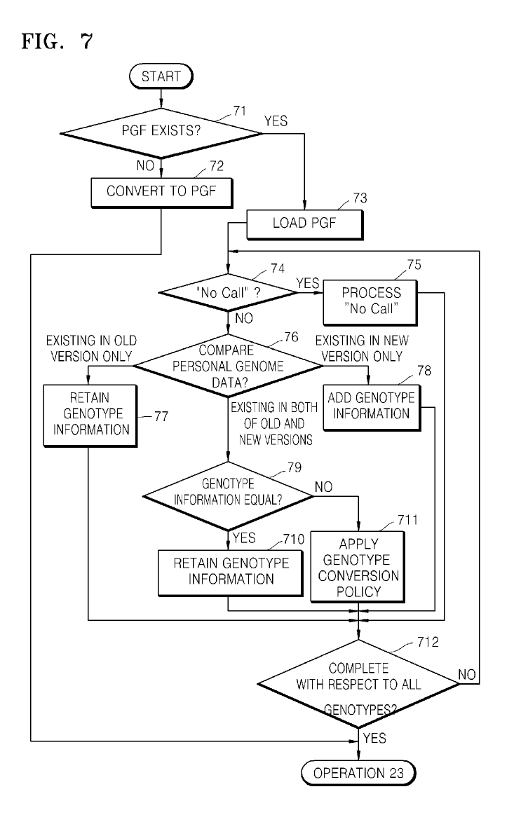

FIG. 7 is a detailed flowchart of an embodiment of operation 22 shown in FIG. 2. Referring to FIG. 7, operation 22 shown in FIG. 2 includes operations that will be described below that are executed by the integrated data generating unit 12 of FIG. 1, in chronological order.

In operation 71, the integrated data generating unit 12 determines whether a PGF corresponding to personal genome data input via the data analyzing unit 11 exists or not, based on property information obtained by the data analyzing unit 11. In other words, the integrated data generating unit 12 determines whether the PGF for the individual is already stored in the PGF database 17. As a result, if a PGF corresponding to the personal genome data input via the data analyzing unit 11 exists, the method proceeds to operation 73. If no PGF corresponding to the personal genome data input via the data analyzing unit 11 exists, the method proceeds to operation 72. Here, a PGF corresponding to personal genome data input via the data analyzing unit 11 refers to a PGF which stores a different version of personal genome data of an individual compared to that of personal genome data input via the data analyzing unit 11.

In operation 72, the integrated data generating unit 12 converts personal genome data input via the data analyzing unit 11 into a PGF. In operation 73, the integrated data generating unit 12 loads a PGF corresponding to the personal genome data input via the data analyzing unit 11 from the PGF database 17.

In operation 74, if related information does not exist among a plurality of genotypes constituting genetic polymorphism information of personal genome data input via the data analyzing unit 11, that is, in the case of “No Call,” the integrated data generating unit 12 proceeds to operation 75. When “No Call” is not the case, the integrated data generating unit 12 proceeds to operation 76. In operation 75, the integrated data generating unit 12 applies a predetermined “No Call” processing policy for processing genotypes corresponding to “No Call.” For example, genotypes corresponding to “No Call” may either be indicated as “No Call” or skipped.

In operation 76, the integrated data generating unit 12 compares the new version of personal genome data input via the data analyzing unit 11 and the old version of personal genome data within the PGF loaded in operation 73. As a result, with respect to a plurality of genotypes constituting genetic polymorphism information of personal genome data, the method proceeds to operation 77 with respect to genotypes existing only in the old version of personal genome data, proceeds to operation 78 with respect to genotypes existing only in the new version of personal genome data, and proceeds to operation 79 with respect to genotypes existing both in the old version and the new version of personal genome data.

In operation 77, the integrated data generating unit 12 retains information regarding the genotypes existing only in the old version of personal genome data in the PGF. In operation 78, the integrated data generating unit 12 converts information regarding the genotypes existing only in the new version of personal genome data into the form of PGF and add it to the existing PGF. In operation 79, the integrated data generating unit 12 compares genotype information of the old version of the personal genome data and genotype information of the new version of the personal genome data. As a result, if the genotype information of the old version of personal genome data and the genotype information of the new version of personal genome data are equal, the method proceeds to operation 710. If the genotype information of the old version of personal genome data and the genotype information of the new version of personal genome data are not equal, the method proceeds to operation 711.

In operation 710, the integrated data generating unit 12 retains genotype information, equal in both the old version and the new version of personal genome data, in the PGF. In operation 711, the integrated data generating unit 12 applies a predetermined genotype conversion policy to determine genotype information existing in both the old version and new version of personal genome data. In the current embodiment, three policies as described below are suggested as genotype conversion policies. However, the policies below are merely examples, and other policies, such as a particular policy designated by a user, may also be applied. In a first embodiment, the genotype conversion policy is to discard genotype information not equal to each other. In a second embodiment, the genotype conversion policy is obtainment of information regarding a genotype again from a predetermined reference sample by requesting the user for genotyping raw data of the genotype. If call rate and synchronization rate between the original genotype information and newly obtained genotype information exceed a predetermined degree, the newly obtained genotype information is selected. In a third embodiment, the genotype conversion policy involves imputation of information regarding genotypes existing both in the old version and the new version of personal genome data by considering the information as missing. The third policy is described in detail by a thesis “Imputation methods to improve inference in SNP association studies (by James Y. Dai, Ingo Ruczinski, Y Michael Leblanc, Charles Kooperberg),” published in “Genet Epidemiol. 2006 December; 30(8):690-702.”

In operation 712, the integrated data generating unit 12 proceeds to operation 23 shown in FIG. 2 in the case where operations 74 through 711 described above are completed with respect to all of a plurality of genotypes constituting genetic polymorphism information of personal genome data input via the data analyzing unit 11, or else returns to operation 74 in the case where operations 74 through 711 described above are not completed with respect to all of a plurality of genotypes constituting genetic polymorphism information of personal genome data input via the data analyzing unit 11. Operations 74 through 711 are performed with respect to each of the plurality of genotype information constituting genetic polymorphism information input via the data analyzing unit 11 in chronological order.

Referring back to FIG. 1, in one embodiment, the storage unit 13 stores integrated data generated by the integrated data generating unit 12, that is, a binary PGF in the PGF database 17. More particularly, the storage unit 13 assorts genotype information within the integrated data generated by the integrated data generating unit 12, that is, the PGF, according to versions of the genotype information, and stores the assorted PGF file in the PGF database 17.

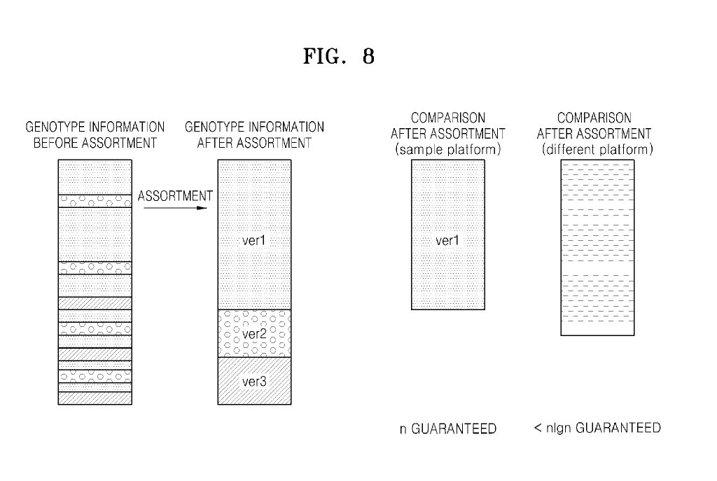

FIG. 8 is a diagram showing an embodiment of the assortment of genotype information within the PGF shown in FIG. 1. Referring to FIG. 8, the storage unit 13 classifies genotype information within the PGF file according to versions of the genotype information, and then arranges the genotype information such that genotype information of the same version are successively arranged. Thus, the number of times personal genome data needs to be compared is minimized. In particular, if property information of personal genome data is the same (e.g. versions of the genome detecting device 10 are the same), the number of times the personal genome data needs to be compared approaches close to n, which is the number of IDs of each of a plurality of genotypes constituting genetic polymorphism information of personal genome data. In other words, n indicates the number of locations of genetic polymorphism. If the genome detecting device 10 can detect 100,000 SNPs, n is 100,000. Furthermore, if property information of personal genome data is not the same, the maximum number of times the personal genome data needs to be compared cannot exceed n×Ig(n). Due to a reduction in the number of times the comparison is made, personal genome data can be managed in a highly efficient manner.

Referring back to FIG. 1, in one embodiment, the service management unit 14 executes at least one service selected by a user from among services provided by the apparatus for integrated personal genome management, and generates a service history of a user, based on a result of the execution. The storage unit 13 stores the service history generated by the service management unit 14 in the link database 18. Here, the services provided by the apparatus for integrated personal genome management, shown in FIG. 1, refer to services providing medical analysis with respect to an individual based on genome information of the individual. Examples of such services include, for example, service of analyzing lineage of an individual, service of analyzing risks of infection with a particular disease of an individual, a service of analyzing peculiar drug reaction of an individual, a service of analyzing a major histocompatibility complex (MHC) of an individual, etc. In particular, the service management unit 14 executes services in linkage with the storage unit 13, the index selecting unit 15, the data comparing unit 16, etc., and transmits a result of the service execution to the user terminal 20. For example, the service management unit 14 generates a report regarding medical analysis of an individual by using a result of comparative analysis of personal genome data, which is the result output by the data comparing unit 16, and transmits the report to the user terminal 20. Thus, a user can view his/her medical analysis report.

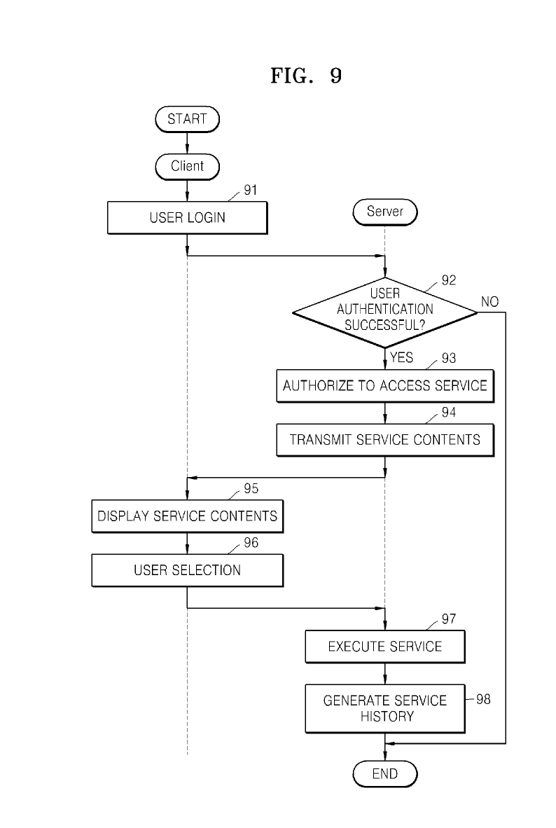

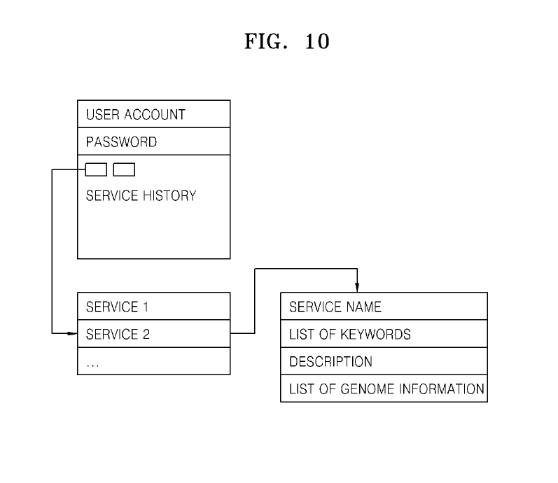

FIG. 9 is a detailed flowchart of an embodiment of the operations 24 and 25 shown in FIG. 2. Referring to FIG. 9, the operations 24 and 25 shown in FIG. 2 include operations that will be described below that are executed by the service management unit 14 of FIG. 1 in chronological order. Especially, the operations 24 and 25 shown in FIG. 2 will be described below in detail by focusing on a relationship between the user terminal 20, which is a client, and the apparatus for integrated personal genome management, which is a server. Communication between a client and a server can be carried out via a wired network, a wireless network, or via other communication media. However, it will be understood by those of ordinary skill in the art that operations described below can also be performed within a single device.

In operation 91, the user terminal 20 receives an input of login information of a user, and transmits the login information to the apparatus for integrated personal genome management shown in FIG. 1. In operation 92, the service management unit 14 performs user authentication based on the login information transmitted from the user terminal 20. As a result, if the user authentication is successful, the method proceeds to operation 93. If the user authentication is unsuccessful, the method is terminated. Generally, user authentication can be embodied by confirming a user account and a password thereof. Since personal genome data is private information of an individual, such user authentication is required.

In operation 93, the service management unit 14 authorizes a user, who is successfully authenticated in the operation 92, to access services provided by the apparatus for integrated personal genome management shown in FIG. 1. In operation 94, the service management unit 14 transmits contents respectively indicating the services provided by the apparatus for integrated personal genome management shown in FIG. 1 to the user terminal 20 of the user authorized to access the services. In operation 95, the user terminal 20 displays service contents transmitted from the apparatus for integrated personal genome management shown in FIG. 1. In operation 96, the user terminal 20 receives an input of the user to select at least one of the contents displayed in the operation 95, and transmits the selection information to the apparatus for integrated personal genome management shown in FIG. 1. In operation 97, the service management unit 14 executes a service corresponding to at least one item of content indicated by the selection information transmitted from the user terminal 20. In operation 98, the service management unit 14 generates the service history of the user based on a result of the service execution in operation 97.

FIG. 10 is a diagram of an example of the service history generated in operation 98 of FIG. 9. Referring to FIG. 10, the service history is stored in the link database 18 after being mapped to a user account and a password thereof indicating a particular user. The service history is classified according to services provided by the apparatus for integrated personal genome management shown in FIG. 1 and is stored, and the service history of a particular service includes a list of keywords a user used to search for content to use the service, descriptions of the service, and genome data related to the service. To prevent duplicate storage of genome data in both the PGF database 17 and the link database 18, a link, which indicates location of the genome data within the PGF database 17, etc., may be stored in the link database 18 instead of the genome data. Accordingly, the link database 18 stores data linked to genome data stored in the PGF database 17.

Based on the service history stored in the link database 18, the index selecting unit 15 selects indexes for each item of genotype information stored in the integrated data, that is, a PGF stored in the PGF database 17. More particularly, the index selecting unit 15 designates priorities of each item of genotype information by counting the number of times that each item of genotype information is searched for from service histories stored in the link database 18, and allocates indexes indicating the priorities to corresponding genotype information. It is not necessary to allocate such indexes to all the genotype information within a PGF stored in the PGF database 17, and the indexes may only be allocated to genotype information that has high frequencies of use.

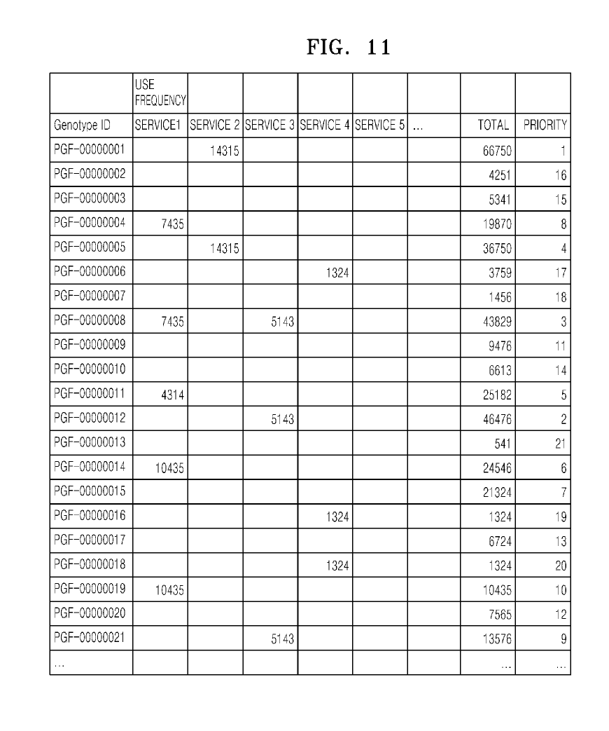

FIG. 11 is a diagram showing an example of the selection of indexes by the index selecting unit 15 shown in FIG. 1. Referring to FIG. 11, it is clear that the priority of genotype information of which the ID is “PGF-00000001” became 1 as a result of the index selecting unit 15 counting the number of times that each item of genotype information is searched for. The index selecting unit 15 allocates an index indicating that the priority of genotype information to which the index corresponds is 1 to the genotype information of which the ID is “PGF-00000001.”

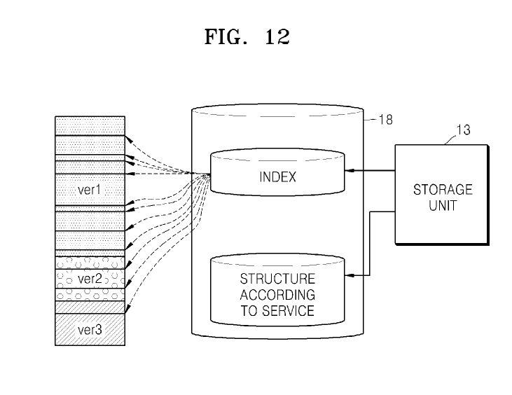

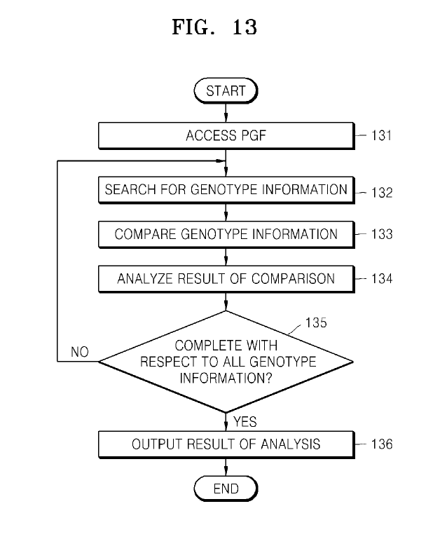

FIG. 12 is a diagram showing an embodiment of the storage of indexes in the storage unit 13 shown in FIG. 1. Referring to FIG. 12, the storage unit 13 maps each of indexes selected by the index selecting unit 15 to each of corresponding genotype information, that is, IDs of SNP and stores the mapped indexes in the link database 18. Thus, the number of times searching and/or comparing genotype information that has high frequencies of use is performed can be significantly reduced. In order to further reduce the number of times searching and/or comparing genotype information that has extremely high frequencies of use is performed, the storage unit 13 may store IDs of the genotype information that has extremely high frequencies of use from among genotype information within a PGF and the genotype information that has extremely high frequencies of use as a data structure in which the IDs and the genotype information are collected according to services.

In one embodiment, the data comparing unit 16 (FIG. 1) searches for a PGF including personal genome data required by the service management unit 14 to execute services from among PGFs stored in the PGF database 17 in reference to link data stored in the link database 18, and performs the comparison with respect to personal genome data within the searched PGF. Performing the comparison comprises comparing personal genome data within a PGF to other data having the same structure as the PGF. For example, the comparison may either comprise comparing personal genome data within a PGF to personal genome data within another PGF or comparing data within a particular file stored in the link database 18 to personal genome data in a PGF. The particular file stored in the link database 18 refers to a file required by a service provided by the apparatus for integrated personal genome management shown in FIG. 1. For example, in the case of a service of analyzing risks to an individual in terms of infection with a particular disease, a file in which genotype information regarding the particular disease is recorded is required. Such a file may be either stored in the apparatus for integrated personal genome management shown in FIG. 1 or input from an external source.

In particular, in order to perform efficient and rapid search and/or comparison of personal genome data, the data comparing unit 16 primarily compares genome information related to a service being executed by the service management unit 14 with respect to a data structure in which genotype information in which has extremely high frequencies of use are collected according to services. If all the personal genome data required by the service management unit 14 to execute a service are not found in the data structure, the data comparing unit 16 refers to indexes stored in the link database 18 and searches and/or compares genotype information within a PGF stored in the PGF database 17 in a descending order of priorities indicated by the indexes, that is, in a descending order of frequencies of use of the genotype information. If all personal genome data required by the service management unit 14 to execute a service are not found in indexes stored in the link database 18, the data comparing unit 16 searches and/or compares all genotype information within a PGF stored in the PGF database 17.

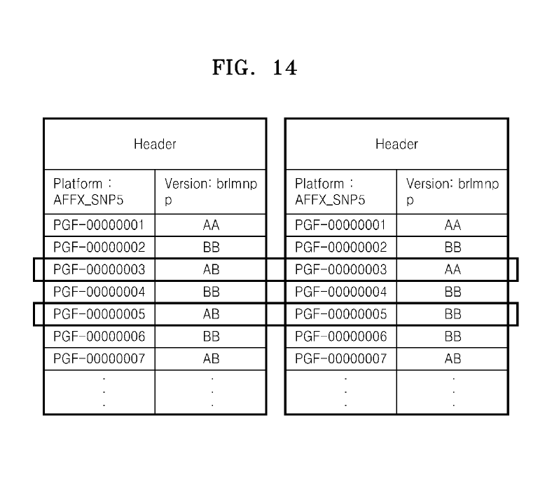

FIG. 13 is a detailed flowchart of an embodiment of the operation 27 shown in FIG. 2. Referring to FIG. 13, the operation 27 shown in FIG. 2 includes operations that will be described below that are executed by the data comparing unit 16 of FIG. 1 in chronological order. Although descriptions below focus on searching and/or comparing PGFs stored in the PGF database 17, the descriptions may also be equally applied to the data structure according to the services described above.

In operation 131, the data comparing unit 16 accesses PGFs including personal genome data required by the service management unit 14 to execute services from among PGFs stored in the PGF database 17. In operation 132, the data comparing unit 16 searches for genotype information within the PGFs accessed in operation 131 in reference to a service history, index, etc. of a service being executed by the service management unit 14. In operation 133, the data comparing unit 16 compares genotype information searched for in the operation 132. In other words, the data comparing unit 16 confirms whether genotype information of a PGF and genotype information of another PGF corresponding to the former PGF are equal or not by comparing the genotype information.

Further, in operation 134, the data comparing unit 16 analyzes a result of the comparison in the operation 133 according to the type of service being executed by the service management unit 14, in reference to files related to the service being executed by the service management unit 14 from among link data stored in the link database 18, wherein an example of the files may be a lineage file of an individual. Operation 134 may also be performed by the service management unit 14. In operation 135, the data comparing unit 16 proceeds to operation 136 in the case where operations 132 through 134 described above are completed with respect to all the genotype information related to a service being executed by the service management unit 14, or returns to operation 132 in the case where the operations 132 through 134 described above are not completed with respect to all the genotype information related to a service being executed by the service management unit 14. In operation 136, the data comparing unit 16 outputs a result of the comparison performed in operation 134 to the service management unit 14.

FIG. 14 is a diagram showing an example of data comparison performed by the data comparing unit 16 shown in FIG. 1. Referring to FIG. 14, the data comparing unit 16 compares genotype information within a PGF and genotype information within another PGF. As a result, it is determined that genotype information of which the ID is “PGF-00000003” and genotype information of which the ID is “PGF-00000005” are not equal to each other. A result of service execution may be generated by reprocessing the result of the comparison, according to the types of services. For example, a report regarding a lineage relationship confirmation between individuals may be generated by using the result of the comparison.

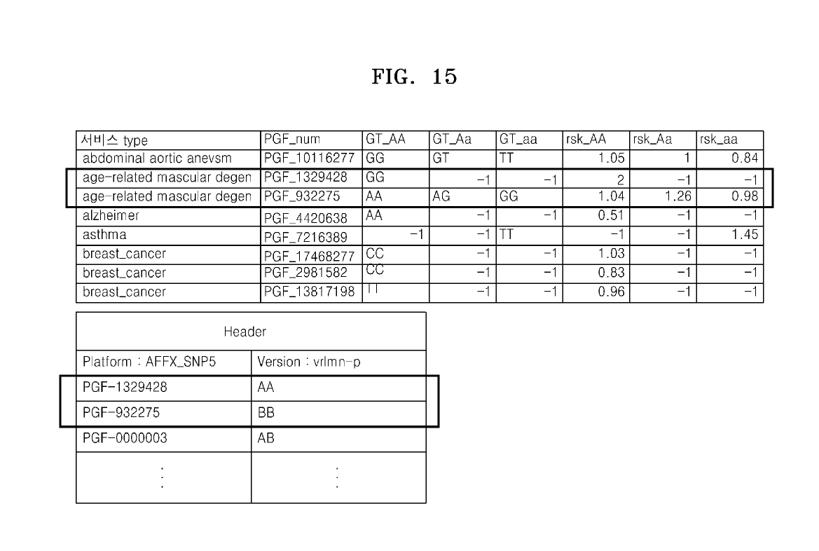

FIG. 15 is a diagram showing another example of data comparison performed by the data comparing unit 16 shown in FIG. 1. Referring to FIG. 15, the data comparing unit 16 compares genotype information regarding a particular disease indicated by a file stored in the link database 18 and genotype information within a PGF file of an individual. In other words, the data comparing unit 16 can predict a risk to an individual of macular degeneration by comparing genotype information regarding age-related macular degeneration and genotype information of the individual. A result of the service execution may be generated by reprocessing the result of the comparison, according to the types of services.

As described above, according to the one or more of the above embodiments, personal genome data can be consistently managed by employing integrated data having a unified data structure which is not subordinated to various structures of personal genome data due to developments in genome sequencing techniques and genome detecting devices.

In addition, other embodiments can also be implemented through computer readable code/instructions in/on a medium, e.g., a computer readable medium, to control at least one processing element to implement any above described embodiment. The medium can correspond to any medium/media permitting the storage and/or transmission of the computer readable code.

The computer readable code can be recorded/transferred on a medium in a variety of ways, with examples of the medium including recording media, such as magnetic storage media (e.g., ROM, floppy disks, hard disks, etc.) and optical recording media (e.g., CD-ROMs, or DVDs).

While the present invention has been particularly shown and described with reference to exemplary embodiments thereof, it will be understood by those of ordinary skill in the art that various changes in form and details may be made therein without departing from the spirit and scope of the present invention as defined by the following claims. Descriptions of features or aspects within each embodiment should typically be considered as available for other similar features or aspects in other embodiments.

What is claimed is:

1. A method of performing integrated personal genome management, the method comprising:
obtaining personal genome data of an individual, wherein personal genome data comprises the property information of the personal genome data and genetic polymorphism information of the individual;
determining whether a second personal genome data for the individual is present; and
generating integrated personal genome data by integrating the personal genome data and the second personal genome data of the individual based on the obtained property information.

2. The method of claim 1, wherein the personal genome data and the second personal genome data file have different data structures, and
the integrated personal genome data has a unified data structure.

3. The method of claim 2, wherein the term ‘different data structures’ includes a difference in terms of at least one of the elements constituting property information of each of the first data and the second data.

4. The method of claim 1, wherein the property information comprises at least one of information regarding a manufacturer of a genome detecting device which generated the first personal genome data, a version of the genome detecting device, and a version of an algorithm the genome detecting device used to generate the first personal genome data.

5. The method of claim 1, wherein the generating of the integrated personal genome data comprises:
comparing the first personal genome data and the second personal genome data; and
either converting genotype information in the first personal genome data into the integrated data or retaining genotype information in the second personal genome data in the integrated personal genome data, according to a result of the comparing.

6. The method of claim 1, wherein the generating of the integrated personal genome data further comprises, with respect to a genotype existing in both the first personal genome data and the second personal genome data, determining information of the genotype according to whether the genotype information in the first personal genome data and the genotype information in the second personal genome data are equal or not.

7. The method of claim 1, wherein the obtaining of the property information comprises:
extracting the property information by parsing the first personal genome data;
determining whether the first personal genome data is eligible for integrated management or not based on the extracted property information; and
selectively outputting the property information based on a result of the determining.

8. A computer readable recording medium having recorded thereon a computer program for executing a method of integrated personal genome management, the method comprising:
obtaining personal genome data of an individual, wherein personal genome data comprises the property information of the personal genome data and genetic polymorphism information of the individual;
determining whether a second personal genome data for the individual is present; and
generating integrated personal genome data by integrating the personal genome data and the second personal genome data of the individual based on the obtained property information.

9. An apparatus for integrated personal genome management, the apparatus comprising:
an analyzing unit which obtains property information of first personal genome data, which indicates genome information of an individual, by analyzing the first data; and
a generating unit which generates integrated personal genome data by integrating the first personal genome data and a second personal genome data indicating genome data of the individual based on the obtained property information.

10. A method of comparing personal genomes, the method comprising:
obtaining property information of a first personal genome data, which indicates genome information of an individual, by analyzing a first personal genome data;
generating integrated personal genome data by integrating the first personal genome data and the second personal genome data indicating genome data of the individual based on the obtained property information; and
comparing the integrated personal genome data and other data that has a structure the same as that of the integrated data.

11. The method of claim 10, wherein the first personal genome data and the second personal genome data have different data structures, and
the integrated personal genome data has a unified data structure.

12. The method of claim 11, further comprising selecting indexes of each of genotype information within the integrated personal genome data according to frequencies of use of the genotype information,
wherein genotype information within the integrated personal genome data and genotype information within other integrated personal genome data are compared in reference to the indexes.

13. The method of claim 12, further comprising:
executing at least one service selected by a user from among services of providing medical analysis of an individual by using the integrated personal genome data; and
generating a service history of the user based on a result of the executing,
wherein indexes of each of genotype information within the integrated personal genome data are selected based on the service history.

14. The method of claim 10, further comprising partially storing the genotype information separately based on frequencies of use of the genotype information within the integrated personal genome data,
wherein the separately stored genotype information is primarily compared to genotype information within the other integrated personal genome data.

15. A computer readable recording medium having recorded thereon a computer program for executing a method of comparing personal genomes, the method comprising:
obtaining property information of first personal genome data, which indicates genome information of an individual, by analyzing the first personal genome data;
generating integrated personal genome data by integrating the first personal genome data and a second personal genome data indicating genome data of the individual based on the obtained property information; and
comparing the integrated personal genome data and other data that has a structure the same as that of the integrated data.

16. An apparatus for comparing personal genomes, the apparatus comprising:
an analyzing unit which obtains property information of first personal genome data, which indicates genome information of an individual, by analyzing the first personal genome data;
a generating unit which generates integrated personal genome data by integrating the first personal genome data and second personal genome data indicating genome data of the individual based on the obtained property information; and
a comparing unit which compares the integrated personal genome data and other data that has a structure the same as that of the integrated data.

17. A method of providing personal genome services, the method comprising:
transmitting contents respectively indicating services of providing medical analysis with respect to an individual by using genome information of the individual, to a user terminal;
receiving selection information with respect to at least one of the contents of the services, from the user terminal;
executing the service indicated by the received selection information by using integrated data in which first data, which indicates genome information of the individual, and second data, which indicates genome information of the individual, are integrated; and
transmitting a result of the service execution to the user terminal.

18. The method of claim 17, further comprising generating a service history based on the result of the service execution.

19. The method of claim 17, further comprising:
executing user authentication based on login information transmitted from the user terminal; and
selectively issuing authorization for accessing services based on a result of the user authentication,
wherein the contents respectively indicating the services are transmitted to the user terminal of the user authorized to access the services.

20. A computer readable recording medium having recorded thereon a computer program for executing a method of providing personal genome services, the method comprising:
transmitting contents respectively indicating services of providing medical analysis with respect to an individual by using genome information of the individual, to a user terminal;
receiving selection information with respect to at least one of the contents of the services, from the user terminal;
executing the service indicated by the received selection information by using integrated data in which first data, which indicates genome information of the individual, and second data, which indicates genome information of the individual, are integrated; and
transmitting a result of the service execution to the user terminal.
